(19) United States
(12) Patent Application Publication
(10) Pub. No.: US 2021/0165298 A1
(43) Pub. Date: Jun. 3, 2021

(54) PANEL, DISPLAY COMPONENT, AND METHOD FOR CONTROLLING VIEW ANGLE OF DISPLAY COMPONENT

(71) Applicant: BEIJING XIAOMI MOBILE SOFTWARE CO., LTD., Beijing (CN)

(72) Inventor: Xiankun HU, Beijing (CN)

(73) Assignee: BEIJING XIAOMI MOBILE SOFTWARE CO., LTD., Beijing (CN)

(21) Appl. No.: 16/852,346

(22) Filed: Apr. 17, 2020

(30) Foreign Application Priority Data
Nov. 29, 2019 (CN) 201911207314.8

(51) Int. Cl. G02F 1/19

(52) U.S. Cl. CPC G02F 1/19

(57) ABSTRACT

The disclosure relates to a panel comprising a first conductive layer that is transparent, a second conductive layer that is transparent, and a refractive-index-variable layer between the first conductive layer and the second conductive layer. A refractive index of the variable-refractive-index layer varies with a voltage applied between the first conductive layer and the second conductive layer.

### CROSS-REFERENCE TO RELATED APPLICATION

This application is based upon and claims priority to Chinese Patent Application 201911207314.8, filed on Nov. 29, 2019, the entirety of which is incorporated herein by reference.

### TECHNICAL FIELD

The disclosure relates to the field of display, and particularly to a panel, a display component, and a method for controlling a view angle of a display component.

### BACKGROUND

With wide application of smart terminal technologies, electronic products with display screens are more and more popular in daily lives. In order to protect privacy, when using an electronic product with a display screen at a densely populated public place, people do not want their private information displayed on the display screen to be seen by other people in the surrounding.

In the related art, a display screen of a mobile phone has a large view angle, resulting in that what is displayed on the display screen can be clearly seen even by people far away from the front side of the display screen. This is not favorable for protecting the privacy of the mobile phone user, since there is a risk of privacy leak.

### SUMMARY

Provided in the disclosure are a panel, a display component, a terminal, a method for controlling a view angle of a display component, and a device for controlling a view angle of a display component.

According to a first aspect of the disclosure, a panel is provided. The panel includes: a first conductive layer that is transparent, a second conductive layer that is transparent, and a variable-refractive-index layer between the first conductive layer and the second conductive layer, wherein a refractive index of the variable-refractive-index layer varies in response to a change of a voltage applied between the first conductive layer and the second conductive layer.

According to a second aspect of the disclosure, provided is a display component including a display screen and the panel provided in any example of the disclosure. The panel is located on an outer surface of the display screen, and the display component has a view angle varying with a refractive index of the variable-refractive-index layer of the panel.

According to a third aspect of the disclosure, provided is a terminal, including: the display component provided in any example of the disclosure, and a processing module, connected with the display component and configured to control the voltage applied between the first and second conductive layers of the panel in the display component.

According to a fourth aspect of the disclosure, provided is a method for controlling a view angle of a display component, applied to the terminal according to any example of the disclosure, and the method including: determining a present display mode of the terminal; in response to the present display mode being a first display mode, applying a first voltage between the first conductive layer and the second conductive layer in the display component, to enable the variable-refractive-index layer between the first conductive layer and the second conductive layer to have a first refractive index, wherein the display component has a first view angle when the variable-refractive-index layer has the first refractive index.

According to a fifth aspect of the disclosure, provided is a terminal, including a memory, a processor and a computer program stored in the memory for running, wherein the computer program, when executed by the processor, implements the method for controlling a view angle of a display component according to any example of the disclosure.

It should be understood that the general description above and detailed description later are merely exemplary and explanatory, and are not intended to restrict the disclosure.

### BRIEF DESCRIPTION OF THE DRAWINGS

The accompanying drawings herein are incorporated into the specification and constitute part of the present specification, illustrate examples consistent with the disclosure and are intended for explaining the principles of the disclosure together with the specification.

FIG. 1A illustrates a schematic structural diagram of a glass panel applied to a display screen in the related art.

FIG. 1B illustrates a schematic structural diagram of a panel according to an example.

FIG. 2 illustrates a schematic structural diagram of a panel according to another example.

FIG. 3 illustrates a schematic structural diagram of an optical transmission structure in a panel according to an example.

FIG. 4 illustrates a schematic diagram of optical paths of light rays in a panel according to an example.

FIG. 5 illustrates a schematic structural diagram of a panel according to another example.

FIG. 6 illustrates a schematic structural diagram of a panel according to another example.

FIG. 7 illustrates a schematic structural diagram of an optical transmission structure in a panel according to another example.

FIG. 8A illustrates a schematic structural diagram of a display component according to an example.

FIG. 8B illustrates a schematic diagram of determining a view angle according to an example.

FIG. 9A illustrates a schematic structural diagram of a terminal according to an example.

FIG. 9B illustrates a schematic structural diagram of a terminal according to an example.

FIG. 10 illustrates a schematic flowchart of a method for determining a view angle of a display component according to an example.

FIG. 11 illustrates a schematic structural diagram of a device for controlling a view angle of a display component according to an example.

### DETAILED DESCRIPTION

Detailed description will be made here to examples, which are illustrated in the accompanying drawings. When drawings are involved in the following description, identical numerals in different drawings refer to identical or similar elements, unless otherwise indicated. Implementations described in the following examples do not mean all the implementations consistent with the disclosure. On the contrary, they are merely examples of devices and methods consistent with some aspects of the disclosure detailed in the appended claims.

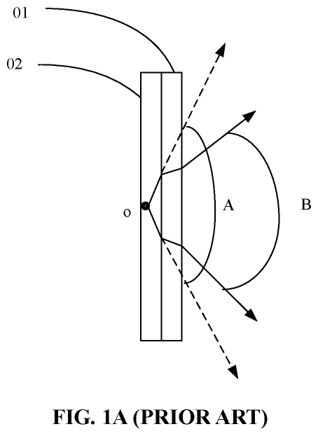

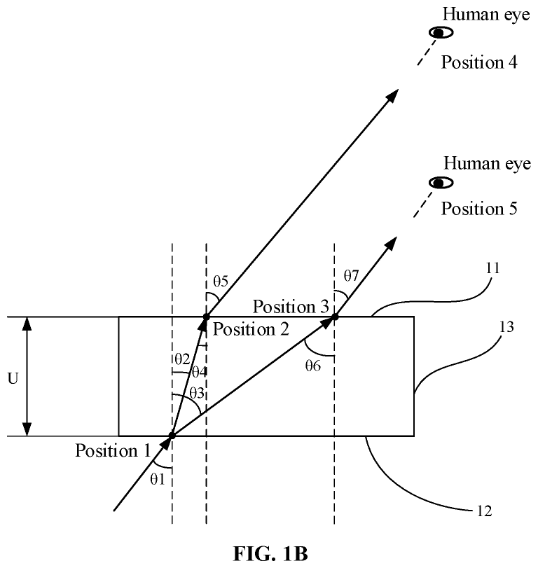

FIG. 1A illustrates a schematic structural diagram of a glass panel applied to a display screen in the related art. The glass panel 01 is attached to a display screen 02 of a terminal (for example a mobile phone). Light rays emitted from a light-emitting point “o” on the display screen 02 pass through the glass panel 01 and then are emergent from a surface of the glass panel 01. A magnitude of a view angle corresponding to the light-emitting point “o” changes from original A to B, where A is greater than B. In this way, the glass panel 01 enables the view angle to be changed smaller so that information displayed at the light-emitting point “o” can only be seen by human eyes within a smaller range, thus obtaining a peep-proof effect. However, the following problem exists with such an implementation: firstly, the glass panel 01 can merely adjust the view angle in the single way, and the view angle cannot be adjusted flexibly; secondly, a user needs to repeatedly tear away and attach the glass panel 01 from/to the display screen 02 to adjust the view angle, which is troublesome in actual operation and may easily cause damage to the display screen 02.

FIG. 1B illustrates a schematic structural diagram of a panel according to an example. As illustrated in FIG. 1B, the panel includes: a first conductive layer 11 that is transparent, a second conductive layer 12 that is transparent, and a variable-refractive-index layer 13 between the first conductive layer 11 and the second conductive layer 12.

A refractive index of the variable-refractive-index layer 13 varies with a voltage applied between the first conductive layer 11 and the second conductive layer 12.

Here, it may be the case where the variable-refractive-index layer 13 has a first refractive-index when a first voltage U1 is applied between the first conductive layer 11 and the second conductive layer 12, and the variable-refractive-index layer 13 has a second refractive-index when a second voltage U2 is applied between the first conductive layer 11 and the second conductive layer 12. Here, the first refractive-index may be greater than the second refractive-index when U1 is greater than U2.

Here, the first conductive layer that is transparent is a first conductive layer through which light rays can pass, and the second conductive layer that is transparent is a second conductive layer through which light rays can pass. Here, the first conductive layer that is transparent and the second conductive layer that is transparent may be conductive layers, each having a light transmittance greater than a set threshold.

Here, the first conductive layer 11 may be a coating layer or a conductive film formed by applying a conductive material on the variable-refractive-index layer 13. The second conductive layer 12 may be a coating layer or a conductive film formed by applying a conductive material on the variable-refractive-index layer 13. The conductive material and the material of the film may be indium tin oxid (ITO). Here, the variable-refractive-index layer 13 may be fabricated by one of the following materials: potassium dihydrogen phosphate (KDP) crystal, lithium niobate (LiNbO3) crystal or gallium arsenide (GaAs) crystal.

Here, the incident light enters the panel at a position 1 with a corresponding incidence angle θ₁. The variable-refractive-index layer 13 has the first refractive-index when the first voltage U1 is applied between the first conductive layer 11 and the second conductive layer 12. At this time, the refraction angle in the variable-refractive-index layer 13 is θ₂. The incidence angle in the variable-refractive-index layer 13 is θ₄, where θ₂=θ₄. The light ray is emergent at a position 2 with a corresponding refraction angle θ₅, where θ₁=θ₅.

The variable-refractive-index layer 13 has the second refractive-index when the second voltage U2 is applied between the first conductive layer 11 and the second conductive layer 12. At this time, the refraction angle in the variable-refractive-index layer 13 is θ₃. The incidence angle in the variable-refractive-index layer 13 is θ₆, where θ₃=θ₆. The light ray is emergent at the position 3 with a corresponding refraction angle θ₇, where θ₁=θ₇,

Here, after a same light ray enters the panel at the position 1, when the second voltage U2 is applied between the first conductive layer 11 and the second conductive layer 12, the light ray entered at the position 1 can be seen by a human eye at a position 5. If the first voltage U1 is applied between the first conductive layer 11 and the second conductive layer 12, the light ray entered at the position 1 can be seen merely by a human eye at a position 4 and cannot be seen by the human eye at the position 5. It is to be noted that in order to make the schematic diagram more clear, the influence of the first conductive layer and the second conductive layer on the optical path is omitted in FIG. 1B.

In examples of the disclosure, by applying a different voltage between the first conductive layer 11 and the second conductive layer 12 to change the refractive index of the refractive-index-variable layer 13, the optical path of a light ray entering the panel at a same position can be changed, so that the emergent angle of the light ray leaving the panel is changed. As such, the view angle of a display screen of a terminal containing the panel can be changed. The requirement of providing different view angles in different application scenarios can be satisfied, and user experience can be promoted.

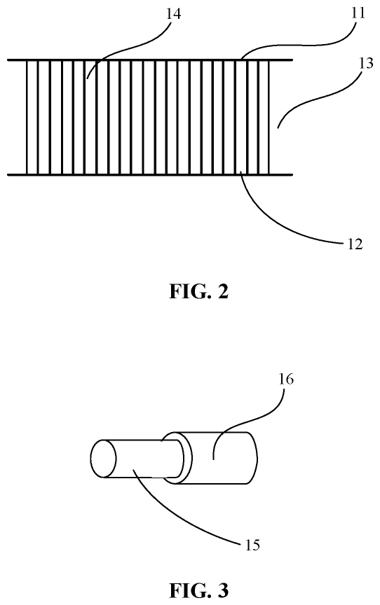

FIG. 2 illustrates a schematic structural diagram of a panel according to another example. As illustrated in FIG. 2, the variable-refractive-index layer 13 includes at least one optical transmission structure 14 between the first conductive layer 11 and the second conductive layer 12. As shown in FIG. 3, the optical transmission structure 14 includes a core 15 and a cladding 16 attached to an outer surface of the core 15, and the core 15 has a refractive index greater than a refractive index of the cladding 16.

At least one of the refractive index of the core 15 or the refractive index of the cladding 16 varies with the voltage applied between the first conductive layer 11 and the second conductive layer 12.

In this example, the refractive index of at least one of the core 15 and the cladding 16 of the optical transmission structure 14 is changed with the applied voltage, so that the refractive index of the entire variable-refractive-index layer 13 is changed.

Here, the cladding may be a coating layer or a film formed by applying a transparent material on an outer surface of the core 15. Here, the core 15 and the cladding 16 may be fabricated by one of the following materials: potassium dihydrogen phosphate (KDP) crystal, lithium niobate (LiNbO3) crystal or gallium arsenide (GaAs) crystal.

Preferably, the optical transmission structure 14 may be fiber.

As shown in FIG. 4, in an example, the refractive index of the core 15 is n₁, and the refractive index of the cladding 16 is n₂, with n1 being greater than n₂. Here, n1 being greater than nz enables light rays entering the core 15 to be totally reflected on a contact surface between the core 15 and the cladding 16, thus reducing energy loss of the light rays. Here, the light rays enter at the position 6. Here, the relation between the view angle α and θ₈ is: α/2≤180-2*θ₈, where sin (θ₈)=n₂/n₁ (n₁>n₂). Here, θ₈ is the incidence angle of the light ray in the core 15 being incident onto the contact surface between the core 15 and the cladding 16.

In an example, the core 15 is fabricated of a variable-refractive-index material, and the cladding 16 is fabricated of an invariable-refractive-index material. The refractive index of the core 15 varies with the voltage applied between the first conductive layer 11 and the second conductive layer 12, and the refractive index of the cladding 16 is not changed.

In an example, the core 15 is fabricated of an invariable-refractive-index material, and the cladding 16 is fabricated of a variable-refractive-index material. The refractive index of the core 15 is not changed, and the refractive index of the cladding 16 varies with the voltage applied between the first conductive layer 11 and the second conductive layer 12. As such, θ₈ can be changed by changing the refractive index of the core 15 or the refractive index of the cladding 16, so as to obtain a different value for α.

In an example, the core 15 is fabricated of a variable-refractive-index material, and the cladding 16 is fabricated of a variable-refractive-index material. The refractive index of the core 15 and the refractive index of the cladding 16 vary with the voltage applied between the first conductive layer 11 and the second conductive layer 12.

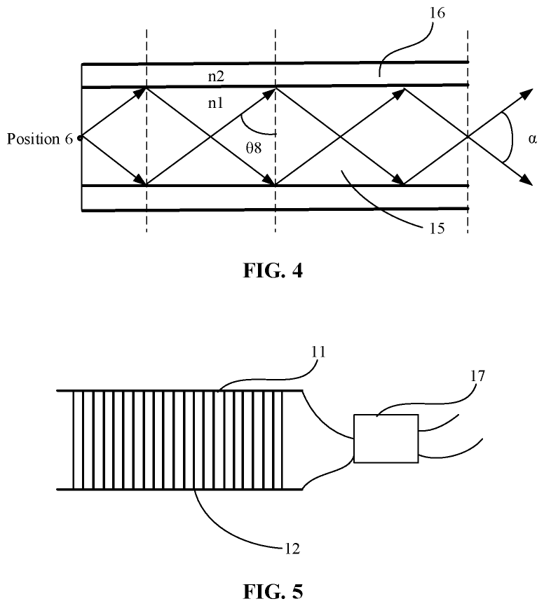

As shown in FIG. 5, in an example, the panel further includes a transformer 17 capable of outputting different voltages.

The transformer 17 is connected to the first conductive layer 11 and the second conductive layer 12 respectively.

For example, the transformer 17 has a first output and a second output. The first output is connected to the first conductive layer 11, and the second output is connected to the second conductive layer 12. One of the first output and the second output is a high voltage output, and the other one is a low voltage output. As such, a voltage difference is produced between the first conductive layer 11 and the second conductive layer 12, so that a voltage of a certain magnitude is applied to the variable-refractive-index layer 13 between the first conductive layer 11 and the second conductive layer 12.

Here, the transformer 17 can output a continuously variable voltage, for example, a voltage of any magnitude between 1 V to 20 V. The transformer 17 may also output discrete voltages, e.g., 1 V, 5 V and 10 V. Here, since the transformer is connected to the first conductive layer 11 and the second conductive layer 12 respectively, and different voltages can be output by the transformer 17, different voltages can be applied between the first conductive layer 11 and the second conductive layer 12.

The transformer 17 includes a primary coil 18 and a plurality of secondary coils 19.

The panel further includes a shift switch 20 for controlling a subset of the secondary coils 19 to be coupled with the primary coil 18 through adjusting a switch state. Each subset of the secondary coils 19, when being coupled with the primary coil 18, causes a respective voltage applied between the first conductive layer 11 and the second conductive layer 12 by the transformer 17.

In some examples, the primary coil may be coupled with one of the secondary coils. In some other examples, the secondary coils may also be coupled with multiple of the secondary coils at the same time. When the primary coil is coupled with multiple of the secondary coils, the voltage output by the transformer may be equal to the voltage of the primary coil. The multiple of the secondary coils may be combined to be coupled with the primary coil to output a transformed voltage.

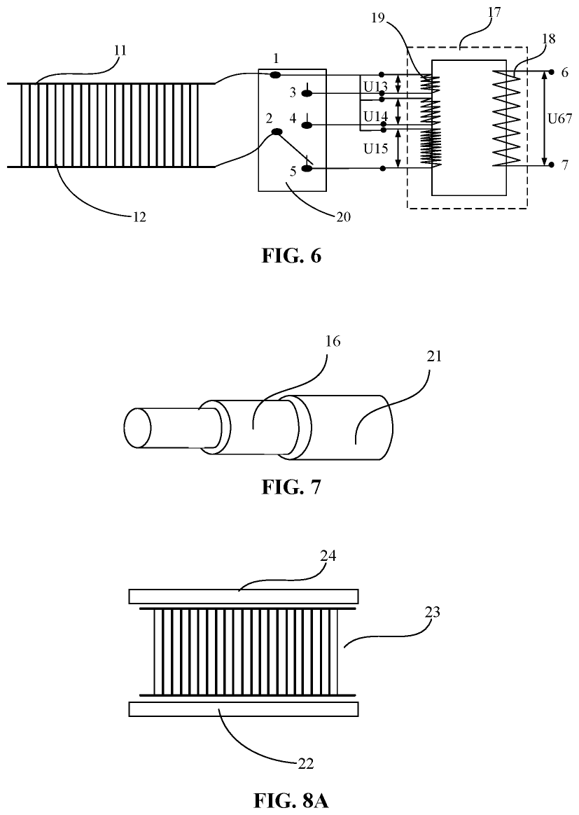

As shown in FIG. 6, in an example, the transformer 17 includes a primary coil 18 and three secondary coils 19. The three secondary coils are a first secondary coil, a second secondary coil and a third secondary coil. An input voltage between a terminal 6 and a terminal 7 of the secondary coil 18 is U₆₇. Voltages output by the first secondary coil, the second secondary coil and the third secondary coil are U₁₃, U₁₄ and U₁₅ respectively. The first secondary coil, the second secondary coil and the third secondary coil have a common terminal 1, and the common terminal 1 is electrically connected to the first conductive layer 11. A non-common terminal 1 of the first secondary coil is electrically connected to a terminal 3 of the shift switch 20. A non-common terminal of the second secondary coil is electrically connected to the terminal 4 of the shift switch 20. A non-common terminal of the third secondary coil is electrically connected to the terminal 5 of the shift switch 20. A terminal 2 of the shift switch 20 is electrically connected to the second conductive layer 12. The switch state includes one of the following: a first switch state in which the terminal 2 is connected to the terminal 3, a second switch state in which the terminal 2 is connected to the terminal 4, and a third switch state in which the terminal 2 is connected to the terminal 5. Here, each of the switch states causes a respective voltage applied between the first conductive layer 11 and the second conductive layer 12. For example, when the switch is in the first switch state, the voltage applied between the first conductive layer 11 and the second conductive layer 12 is U₁₃. When the switch is in the second switch state, the voltage applied between the first conductive layer 11 and the second conductive layer 12 is U₁₄. When the switch is in the third switch state, the voltage applied between the first conductive layer 11 and the second conductive layer 12 is U₁₅.

It is to be noted that the transformer 17 may be arranged within the panel in this example. Alternatively, in this example, the panel may also be merely provided with an interface for connecting to the transformer 17, and the transformer 17 can be arranged on another component (instead of the panel) of the terminal.

As shown in FIG. 7, a protective layer 21 formed of a transparent material is provided on an outer surface of the cladding 16. Here, the cladding 16 may be a coating layer or a film formed by applying a transparent layer on an outer surface of the core 15. The transparent material has a light transmittance greater than a third set threshold. The protective layer 21 can protect the cladding 16 from being damaged during manufacturing of the panel, which would affect reflection of light rays at a contact surface between the core 15 and the cladding 16.

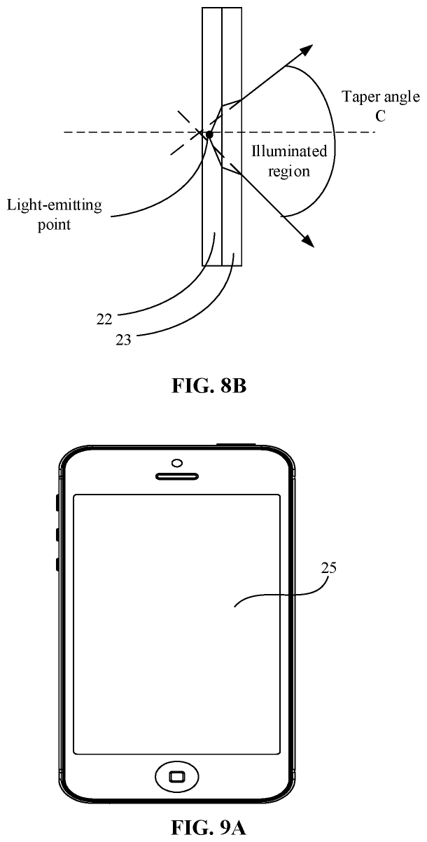

FIG. 8A illustrates a schematic structural diagram of a display component according to an example. As illustrated in FIG. 8A, the display component includes a display screen 22 and the panel 23 provided in any example of the disclosure.

The panel 23 is located on an outer surface of the display screen 22.

The display component has a view angle varying with a refractive index of the variable-refractive-index layer of the panel.

In an example, when the variable-refractive-index layer have a first refractive index, the display component has a first view angle. When the variable-refractive-index layer has a second refractive index, the display component has a second view angle. The first view angle is smaller than the second view angle.

Here, the display screen may be a display screen of a mobile phone, a display screen of a computer, a display screen of a smart television, etc. Since the first view angle is smaller than the second view angle, the view angle within which the content displayed on the display screen 22 is visible can be reduced. In this way, it would be difficult for other people to peep the information displayed on the display screen 22, so as to promote the security of the information.

In an example, as shown in FIG. 8B, a light-emitting point on the display screen 22 may be taken as an origin to determine a plane passing through the origin and perpendicular to the display screen. After passing through the panel 23, light rays from the light-emitting point will form a tapered illuminated area on the plane. The taper angle C of the cone may be determined as the view angle. In an example, the display component further includes a transparent protective glass 24.

The panel 23 is located between the display screen 22 and the protective glass 24.

The protective glass 24 can protect the panel 23 and the display screen 22 from being damaged.

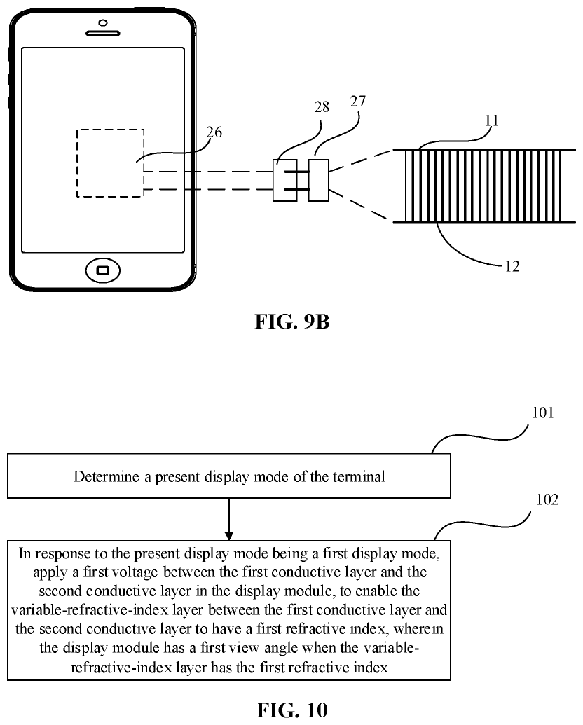

FIG. 9A illustrates a schematic structural diagram of a terminal according to an example. As illustrated in FIG. 9A, the terminal includes the display component 25 provided in any example of the disclosure, and a processing module connected with the display component 25 and configured to control the voltage applied between the first and second conductive layers of the panel in the display component 25.

The terminal may be a mobile phone, a computer, a smart television, etc. The processing module may be a mainboard or processor of the terminal. As shown in FIG. 9B, the display component 25 may be inserted, via a plug 27, into a socket 28 connected to the mainboard or processor 26 of the terminal.

The processing module may apply, according to an operation instruction of a user, a different voltage between the first conductive layer 11 and the second conductive layer 12 of the panel in the display component 25, so that the refractive index of the variable-refractive-index layer 13 of the panel is changed, so as to adjust the view angle of the display component 25.

FIG. 10 illustrates a schematic flowchart of a method for determining a view angle of a display component according to an example. As illustrated in FIG. 10, the method is applied to the terminal according to any example of the disclosure. The method includes the following steps.

At step 101, a present display mode of the terminal is determined.

The present display mode may be one selected from multiple selectable display modes at present. The display component has different view angles in different display modes.

The terminal has two or more display modes. In the examples of the disclosure, the first display mode and the second display mode merely refer to any two different display modes in general.

For example, in a display mode, the display component has a view angle of 30°, and in another display mode, the display component has a view angle of 45°. For example, if a user selects, on a setting interface displayed on a display screen of a terminal, a setting option of a display mode with a view angle of 45°, then the present display mode of the terminal is the display mode with the view angle of 45°. Since the display component has a view angle of 45° in this display mode, the user can only see information displayed on the display screen of the terminal within the view angle of 45°.

At step 102, in response to the present display mode being a first display mode, a first voltage is applied between the first conductive layer 11 and the second conductive layer 12 in the display component, to enable the refractive-index-variable layer between the first conductive layer 11 and the second conductive layer 12 to have a first refractive index. The display component has a first view angle with the first refractive index of the refractive-index-variable layer.

In an example, in response to the present display mode being the first display mode, the first voltage is applied between the first conductive layer 11 and the second conductive layer 12 in the display component, to enable the variable-refractive-index layer between the first conductive layer 11 and the second conductive layer 12 to have the first refractive index. In response to the present display mode being a second display mode, a second voltage is applied between the first conductive layer 11 and the second conductive layer 12 in the display component, to enable the refractive-index-variable layer between the first conductive layer 11 and the second conductive layer 12 to have a second refractive index. The display component has a first view angle with the first refractive index of the refractive-index-variable layer. The display component has a second view angle with the second refractive index of the variable-refractive-index layer. The first view angle is smaller than the second view angle. When the voltage applied between the first conductive layer 11 and the second conductive layer 12 is changed from the second voltage to the first voltage, the view angle is changed from the second view angle to the first view angle, thus reducing the view angle.

According to different display modes, different voltages are applied between the first conductive layer 11 and the second conductive layer 12 in the display component. This will change the view angle of the display component, so that a human eye can only see information displayed in the display component within partial region (within the view angle) in front of the display component, facilitating protecting privacy.

In an example, the terminal is further provided with a transformer. The method further includes the following step.

At step 103, an output voltage of the transformer 17 is controlled according to the present display mode. The output voltage of the transformer 17 is applied between the first conductive layer 11 and the second conductive layer 12.

Here, the transformer 17 may be controlled to output a continuously variable voltage. As such, the magnitude of the view angle may also be continuously variable, and the control over the view angle is more exquisite. For example, if the transformer 17 is controlled to output a voltage continuously variable in a range from 5 V to 10 V, the view angle may be continuously variable in a range from 30° to 60°.

Here, the transformer 17 may also be controlled to output discrete voltages, so that the magnitude of the view angle may be changed among different discrete values. For example, if the transformer 17 is controlled to output voltages 5 V, 7.5 V and 10 V, the view angles may be 30°, 45° and 60° correspondingly.

In step 103, the operation of controlling the output voltage of the transformer 17 according to the present display mode includes the following step:

At step 104, according to the present display mode, a subset of the secondary coils 19 in the transformer 17 is controlled to be coupled with the primary coil 18, through adjusting a switch state of a shift switch 20. Each subset of the secondary coils 19, when being coupled with the primary coil 18, causes a respective voltage applied between the first conductive layer 11 and the second conductive layer 12 by the transformer 17.

The transformer 17 may include a plurality of secondary coils 19. Each of the secondary coils 19 outputs a respective voltage. For example, the first secondary coil correspondingly outputs a voltage of 5V. The second secondary coil correspondingly outputs a voltage of 7.5V. The third secondary coil correspondingly outputs a voltage of 10V. The state of the switch may be a state in which the shift switch 20 connects the first conductive layer 11 and the second conductive layer 12 to one of the secondary coils 19. Here, when the first conductive layer 11 and the second conductive layer 12 are connected to the first secondary coil, a voltage of 5 V is applied between the first conductive layer 11 and the second conductive layer 12.

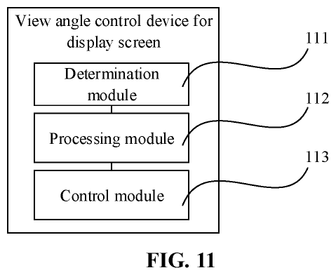

FIG. 11 illustrates a schematic structural diagram of a device for controlling a view angle of a display component according to an example. As illustrated in FIG. 11, the device for controlling a view angle of a display component is applied to the terminal according to any example of the disclosure. The device includes a determination module 111 and a processing module 112.

The determination module 111 is configured to determine a present display mode of the terminal.

The processing module 112 is configured to: in response to the present display mode being a first display mode, apply a first voltage between the first conductive layer and the second conductive layer in the display component, to enable the variable-refractive-index layer between the first conductive layer and the second conductive layer to have a first refractive index; and in response to the present display mode being a second display mode, apply a second voltage between the first conductive layer and the second conductive layer in the display component, to enable the refractive-index-variable layer between the first conductive layer and the second conductive layer to have a second refractive index. The display component has a first view angle with the first refractive index of the refractive-index-variable layer. The display component has a second view angle with the second refractive index of the variable-refractive-index layer. The first view angle is smaller than the second view angle.

In an example, the device further includes a control module 113. The control module 113 is configured to control an output voltage of the transformer according to the present display mode. The output voltage of the transformer is applied between the first conductive layer and the second conductive layer.

In an example, the control module 113 is further configured to control, according to the present display mode, a subset of the secondary coils in the transformer to be coupled with the primary coil, through adjusting a switch state of a shift switch. Each subset of the secondary coils, when being coupled with the primary coil, causes a respective voltage applied between the first conductive layer and the second conductive layer by the transformer.

Further provided in examples of the disclosure is a terminal, including a memory, a processor and a computer program stored in the memory for running. The computer program, when executed by the processor, implements the method for controlling a view angle of a display component according to any example of the disclosure.

The technical solution provided in the examples of the disclosure may have the following beneficial effects:

In the examples of the disclosure, the panel includes a first conductive layer that is transparent; a second conductive layer that is transparent, wherein light rays can enter through the first conductive layer and the second conductive; and a refractive-index-variable layer between the first conductive layer and the second conductive layer. A refractive index of the variable-refractive-index layer varies with a voltage applied between the first conductive layer and the second conductive layer. Here, by applying a different voltage between the first conductive layer and the second conductive layer to change the refractive index of the refractive-index-variable layer, the optical path of a light ray entering the panel through a same position can be changed, so that the emergent angle of the light ray leaving the panel is changed. As such, the view angle of a display screen of a terminal (for example, a display screen of a mobile phone) containing the panel can be changed. The requirement of providing different view angles in different application scenarios can be satisfied, and user experience can be promoted.

Other examples of the disclosure would readily occur to those skilled in the art when considering the specification and practicing the disclosure here. The disclosure is aimed at covering any variants, usages or adaptive changes that comply with generic principles of the disclosure and include common knowledge or customary technical means in the art that is not disclosed in the disclosure. The specification and examples are merely considered exemplary, and the true scope and spirit of the disclosure are specified by the appended claims.

It should be understood that the disclosure is not limited to the precise structures described above and illustrated in the accompanying drawings, and modifications and changes may be made thereto without departing from the scope thereof. The scope of the disclosure is merely defined by the appended claims.

What is claimed is:

1. A panel, comprising:
a first conductive layer that is transparent;
a second conductive layer that is transparent; and
a variable-refractive-index layer between the first conductive layer and the second conductive layer,
wherein a refractive index of the variable-refractive-index layer varies in response to a change of a voltage applied between the first conductive layer and the second conductive layer.

2. The panel according to claim 1, wherein the variable-refractive-index layer comprises: at least one optical transmission structure between the first conductive layer and the second conductive layer, the optical transmission structure comprises a core and a cladding attached to an outer surface of the core, and the core has a refractive index greater than a refractive index of the cladding; and
at least one of the refractive index of the core or the refractive index of the cladding varies in response to the change of the voltage applied between the first conductive layer and the second conductive layer.

3. The panel according to claim 1, further comprising:
a transformer capable of outputting different voltages,
wherein the transformer is connected respectively to the first conductive layer and the second conductive layer .

4. The panel according to claim 3, wherein the transformer comprises a primary coil and a plurality of secondary coils; and
wherein the panel further comprises a shift switch for controlling a subset of the plurality of the secondary coils to be coupled with the primary coil through adjusting a switch state, and
wherein each subset of the plurality of the secondary coils, when being coupled with the primary coil, causes a respective voltage applied between the first conductive layer and the second conductive layer by the transformer.

5. The panel according to claim 2, wherein a transparent protective layer is disposed on an outer surface of the cladding.

6. A display component, comprising a display screen and the panel according to claim 1, wherein the panel is located on an outer surface of the display screen, and
the display component has a view angle varying with a refractive index of the variable-refractive-index layer of the panel.

7. The display component according to claim 6, further comprising a transparent protective glass,
wherein the panel is located between the display screen and the transparent protective glass.

8. The display component according to claim 1, wherein the variable-refractive-index layer comprises: at least one optical transmission structure between the first conductive layer and the second conductive layer, the optical transmission structure comprises a core and a cladding attached to an outer surface of the core, and the core has a refractive index greater than a refractive index of the cladding; and
at least one of the refractive index of the core or the refractive index of the cladding varies in response to the change of the voltage applied between the first conductive layer and the second conductive layer.

9. The display component according to claim 1, wherein the panel further comprises:
a transformer capable of outputting different voltages,
wherein the transformer is connected respectively to the first conductive layer and the second conductive layer.

10. The display component according to claim 9, wherein the transformer comprises a primary coil and a plurality of secondary coils; and
wherein the panel further comprises a shift switch for controlling a subset of the plurality of the secondary coils to be coupled with the primary coil through adjusting a switch state, and
wherein each subset of the plurality of the secondary coils, when being coupled with the primary coil, causes a respective voltage applied between the first conductive layer and the second conductive layer by the transformer.

11. The display component according to claim 8, wherein a transparent protective layer is disposed on an outer surface of the cladding.

12. A terminal, comprising:
the display module according to claim 6, and
a processor, connected with the display component and configured to control the voltage applied between the first and second conductive layers of the panel in the display component.

13. The terminal according to claim 12, wherein the display component further comprises a transparent protective glass,
wherein the panel is located between the display screen and the transparent protective glass.

14. A method, comprising:
determining, by a terminal comprising a display component, a present display mode of the terminal;
in response to the present display mode being a first display mode, applying, by the terminal, a first voltage between a first conductive layer and a second conductive layer in the display component of the terminal, to enable a variable-refractive-index layer between the first conductive layer and the second conductive layer to have a first refractive index; and
wherein the display component has a first view angle when the variable-refractive-index layer has the first refractive index.

15. The method according to claim 14, further comprising:
in response to the present display mode being a second display mode, applying a second voltage between the first conductive layer and the second conductive layer in the display component, to enable the variable-refractive-index layer between the first conductive layer and the second conductive layer to have a second refractive index, wherein the display component has a second view angle with the variable-refractive-index layer having the second refractive index.

16. The method according to claim 14, wherein the terminal further comprises a transformer, and the method further comprises:
controlling an output voltage of the transformer according to the present display mode, wherein the output voltage of the transformer is applied between the first conductive layer and the second conductive layer.

17. The method according to claim 16, wherein controlling the output voltage of the transformer according to the present display mode comprises:
controlling, according to the present display mode, a subset of a plurality of secondary coils in the transformer to be coupled with the primary coil, through adjusting a switch state of a shift switch,
wherein each subset of the plurality of the secondary coils, when being coupled with the primary coil, causes a respective voltage applied between the first conductive layer and the second conductive layer by the transformer.

18. A terminal, comprising a display component, a non-transitory computer-readable memory, one or more processors and a computer program stored in the non-transitory computer-readable memory for running, wherein the computer program, when executed by the one or more processors, causes the terminal to performing acts comprising:
determining a present display mode of the terminal;
in response to the present display mode being a first display mode, applying a first voltage between a first conductive layer and a second conductive layer in a display component, to enable a variable-refractive-index layer between the first conductive layer and the second conductive layer to have a first refractive index; and
wherein the display component has a first view angle when the variable-refractive-index layer has the first refractive index.

19. The terminal, according to claim 18, wherein the acts further comprise:
in response to the present display mode being a second display mode, applying a second voltage between the first conductive layer and the second conductive layer in the display component, to enable the variable-refractive-index layer between the first conductive layer and the second conductive layer to have a second refractive index, wherein the display component has a second view angle with the variable-refractive-index layer having the second refractive index.

20. The terminal according to claim 18, further comprising a transformer, and the acts further comprise:
controlling an output voltage of the transformer according to the present display mode, wherein the output voltage of the transformer is applied between the first conductive layer and the second conductive layer.
